(19) United States
(12) Patent Application Publication
(10) Pub. No.: US 2024/0348474 A1
(43) Pub. Date: Oct. 17, 2024

(54) METHOD AND SYSTEM FOR OBTAINING LINK NODE DATA

(71) Applicant: ZHEJIANG LAB, Hangzhou City, Zhejiang Province (CN)

(72) Inventors: Xingyu LIU, Hangzhou City, Zhejiang Province (CN); Shaoyong LI, Hangzhou City, Zhejiang Province (CN); Wenjiao YANG, Hangzhou City, Zhejiang Province (CN)

(21) Appl. No.: 18/251,385

(22) PCT Filed: Mar. 15, 2023
(86) PCT No.: PCT/CN2023/081580

§ 371 Date: May 1, 2023

(30) Foreign Application Priority Data
Nov. 17, 2022 (CN) 202211463457.7

(51) Int. Cl. H04L 12/437; H04L 12/42; H04L 41/0668

(52) U.S. Cl. CPC H04L 12/437; H04L 41/0668; H04L 2012/421

(57) ABSTRACT

A method and system for obtaining link node data is provided. The method is applied to an industrial control ring network system including a master station device and a plurality of node devices, and includes: after receiving a link fault message, the master station device determines to transmit a first link location acquisition message to a first network port and/or a second network port based on respective on-off states; each node device processes the first link location acquisition message to obtain and transmit a second link location acquisition message; the master station device parses the second link location acquisition message and transmits a first node data acquisition message; the node device processes the first node data acquisition message to obtain and transmit a second node data acquisition message; and the master station device parses the second node data acquisition message to obtain data of at least one node device.

### TECHNICAL FIELD

The present disclosure relates to the field of industrial control ring network technologies, in particular to a method and system for obtaining link node data and a computer readable storage medium.

### BACKGROUND

With increasing requirements of an industrial control ring network system for the reliability and real-time performance of an industrial control network, the industrial control network mostly uses a ring network networking manner to improve the reliability and real-time performance of the industrial control network. However, when there are one or more interruptions in an industrial control ring network link, it is necessary for a master station device in the industrial control ring network system to spend a long time to obtain a network topology again after disconnection, thereby increasing the convergence time of the industrial control network. Meanwhile, after the industrial control ring network link is interrupted, the master station device in the existing industrial control ring network system mostly uses a point-to-point manner to obtain data of node devices on the industrial control ring network link. With the increase of nodes on the industrial control ring network link, an amount of data that each of the node devices needs to upload is large or small, therefore, using, by the master station device, the point-to-point manner to obtain the data seriously reduces the efficiency of data acquisition. In addition, this point-to-point manner cannot maximize a data carrying capacity of network protocols, and thus the real-time performance of the industrial control ring network system is further reduced.

### SUMMARY

The objective of the present disclosure is to provide a method and system for obtaining link node data and a computer readable storage medium to overcome the defects in the related art.

Embodiments of the present disclosure provide method for obtaining link node data, being applicable to an industrial control ring network system, wherein the industrial control ring network system includes a master station device and a plurality of node devices, the method including: after receiving a link fault message, by the master station device, switching to a link disconnected working mode, and determining to transmit a first link location acquisition message to at least one of a first network port or a second network port of the master station device based on respective on-off states of the first network port and the second network port of the master station device; after receiving the first link location acquisition message, by each of the plurality of node devices, processing the first link location acquisition message to obtain a second link location acquisition message, and transmitting the second link location acquisition message through a first network port or a second network port of the node device; after receiving the second link location acquisition message, by the master station device, parsing the second link location acquisition message, and determining to transmit a first node data acquisition message to at least one of the first network port or the second network port of the master station device based on the respective on-off states of the first network port and the second network port of the master station device; after receiving the first node data acquisition message, by the node device, processing the first node data acquisition message to obtain a second node data acquisition message, and transmitting the second node data acquisition message through the first network port or the second network port of the node device; and after receiving the second node data acquisition message, by the master station device, parsing the second node data acquisition message to obtain data of at least one node device in the plurality of node devices.

In some embodiments, before receiving the link fault message, the method further includes: when all links in a ring network are in a loop connected state, obtaining, by the master station device, data of respective node devices through a loop; and when a link between two node devices in the ring network fails or a node device fails, respectively transmitting, by node devices at both sides of a disconnected link, the link fault message to the master station device.

In some embodiments, determining to transmit the first link location acquisition message to at least one of the first network port or the second network port of the master station device based on the respective on-off states of the first network port and the second network port of the master station device includes: determining, by the master station device, whether one of the first network port and the second network port of the master station device is corresponding to a disconnected link; in response to that the first network port of the master station device is corresponding to a disconnected link, transmitting, by the master station device, the first link location acquisition message to the second network port of the master station device; in response to that the second network port of the master station device is corresponding to a disconnected link, transmitting, by the master station device, the first link location acquisition message to the first network port of the master station device; and in response to that none of the first network port and the second network port of the master station device is corresponding to a disconnected link, transmitting, by the master station device, the first link location acquisition message to a disconnected link through the first network port and the second network port of the master station device respectively, wherein the first link location acquisition message is a broadcast message, and includes a message command, a destination internet protocol (IP) address, an IP address of the master station device and a first link location serial number.

In some embodiments, after receiving the first link location acquisition message, by each of the plurality of node devices, processing the first link location acquisition message to obtain the second link location acquisition message, and transmitting the second link location acquisition message through the first network port or the second network port of the node device includes: determining, by the node device, whether a destination address of the first link location acquisition message is the IP address of the master station device; in response to that the destination address of the first link location acquisition message is the IP address of the master station device, by the node device, not processing the first link location acquisition message, and directly transmitting the first link location acquisition message through the second network port of the node device; in response to that the destination address of the first link location acquisition message is the destination IP address of the broadcast message, parsing, by the node device, the first link location acquisition message to obtain the IP address of the master station device and the first link location serial number; by the node device, storing the IP address of the master station device, and adding 1 to the first link location serial number to obtain a second link location serial number; adding, by the node device, an IP address of the node device and the second link location serial number to an end of the first link location acquisition message to obtain a second link location acquisition message; determining, by the node device, whether the node device is an endpoint device of the disconnected link; in response to that the node device is the endpoint device of the disconnected link, by the node device, changing a destination address of the second link location acquisition message to the IP address of the master station device, and transmitting the second link location acquisition message through the first network port of the node device; and in response to that the node device is not the endpoint device of the disconnected link, transmitting, by the node device, the second link location acquisition message through the second network port of the node device.

In some embodiments, after receiving the second link location acquisition message, by the master station device, parsing the second link location acquisition message includes: after the first network port or the second network port of the master station device receives the second link location acquisition message, by the master station device, parsing the second link location acquisition message to obtain a number of node devices on a link branch corresponding to the first network port or the second network port together with an IP address and a link location serial number of each of the node devices, and creating a mapping relationship table between IP addresses and link location serial numbers of the node device.

In some embodiments, determining to transmit the first node data acquisition message to at least one of the first network port or the second network port based on the respective on-off states of the first network port and the second network port of the master station device includes: in response to that the first network port of the master station device is corresponding to a disconnected link, transmitting, by the master station device, the first node data acquisition message to the disconnected link through the second network port of the master station device; in response to that the second network port of the master station device is corresponding to a disconnected link, transmitting, by the master station device, the first node data acquisition message to the disconnected link through the first network port of the master station device; and in response to that both the first network port and the second network port of the master station device receive the second link location acquisition message, transmitting, by the master station device, a first node data acquisition message to a disconnected link through the first network port and the second network port of the master station device respectively, wherein the first node data acquisition message is the broadcast message, and includes the message command, the destination IP address, a device serial number of a starting node device in node devices that need to obtain data and a message length.

In some embodiments, after receiving the first node data acquisition message, by the node device, processing the first node data acquisition message to obtain a second node data acquisition message, and transmitting the second node data acquisition message through the first network port or the second network port of the node device includes: determining, by the node device, whether a destination address of the first node data acquisition message is the IP address of the master station device; in response to that the destination address of the first node data acquisition message is the IP address of the master station device, directly transmitting, by the node device, the first node data acquisition message through the second port of the node device; in response to that the destination address of the first node data acquisition message is the destination IP address of the broadcast message, parsing, by the node device, the first node data acquisition message to obtain the message length of the first node data acquisition message and the device serial number of the starting node device; determining, by the node device, whether a sum of the message length of the first node data acquisition message and a data length to be uploaded by the node device is less than or equal to a maximum data length carried by a network protocol; in response to that the sum of the message length of the first node data acquisition message and the data length to be uploaded by the node device is less than or equal to the maximum data length carried by the network protocol, determining, by the node device, whether the device serial number of the starting node device is less than or equal to the link location serial number of the node device; in response to that the device serial number of the starting node device is less than or equal to the link location serial number of the node device, adding, by the node device, an IP address of the node device and data to be uploaded to an end of the first node data acquisition message to obtain a second node data acquisition message; determining, by the node device, whether the node device is an endpoint device of the disconnected link; in response to that the node device is the endpoint device of the disconnected link, by the node device, changing a destination address of the second node data acquisition message to the IP address of the IP address of the master station device, and transmitting the second node data acquisition message through the first network port of the node device; and in response to that the node device is not the endpoint device of the disconnected link, transmitting, by the node device, the second node data acquisition message through the second network port of the node device; in response to that the device serial number of the starting node device is greater than the link location serial number of the node device, directly transmitting, by the node device, the first node data acquisition message through the second network port of the node device; in response to that the sum of the message length of the first node data acquisition message and the data length to be uploaded by the node device is greater than the maximum data length carried by the network protocol, determining, by the node device, whether the node device is the endpoint device of the disconnected link; in response to that the node device is the endpoint device of the disconnected link, by the node device, changing the destination address of the first node data acquisition message to the IP address of the IP address of the master station device, and transmitting the first node data acquisition message through the first network port of the node device; and in response to that the node device is not the endpoint device of the disconnected link, transmitting, by the node device, the first node data acquisition message through the second network port of the node device.

In some embodiments, after receiving the second node data acquisition message, by the master station device, parsing the second node data acquisition message to obtain data of at least one node device in the plurality of node devices includes: after the first network port or the second network port of the master station device receives the second node data acquisition message, by the master station device, parsing the second node data acquisition message to obtain data of respective node devices and an IP address of a last node device in the second node data acquisition message, and obtaining a link location serial number corresponding to the IP address of the last node device according to the mapping relationship table; determining, by the master station device, whether the link location serial number of the last node device is less than the number of node devices on the link branch; in response to that the link location serial number of the last node device is less than the number of node devices on the link branch, by the master station device, adding 1 to a device serial number of a starting node device in node devices that need to obtain data in the first node data acquisition message, and transmitting the first node data acquisition message through the first network port or the second network port of the master station device; and in response to that the link location serial number of the last node device is equal to the number of node devices on the link branch, transmitting, by the master station device, the first node data acquisition message through the first network port or the second network port of the master station device, wherein the device serial number of the starting node device in node devices that need to obtain data in the first node data acquisition message is unchanged.

The embodiments of the present disclosure provide a system for obtaining link node data, including a memory and one or more processors, wherein the memory stores executable codes, and when executed by the processors, the executable codes cause the processors to implement the above method for obtaining link node data.

The embodiments of the present disclosure provides a computer readable storage medium storing programs thereon, wherein when executed by one or more processors, the programs cause the processors to implement the above method for obtaining link node data.

According to the technical solutions provided by the embodiments of the present disclosure, when the link of the industrial control ring network system is interrupted, the master station device can quickly obtain the network topology after disconnection and perform network reorganization. Meanwhile, the master station device can make maximum use of the capacity of the network protocol to obtain the data of respective node devices according to the amount of data that respective node devices need to upload, and then can quickly obtain the data of respective node devices, thereby ensuring the real-time performance and reliability of the network of the industrial control ring network system.

### BRIEF DESCRIPTION OF THE DRAWINGS

FIG. 1 is a schematic diagram illustrating a connection between a master station device with node devices in an industrial control ring network system when a link is in a normal state according to an embodiment of the present disclosure.

FIG. 2 is a schematic diagram illustrating a connection between a master station device with node devices in an industrial control ring network system when a link is in an abnormal state according to an embodiment of the present disclosure.

FIG. 3 is a schematic diagram illustrating a connection between a master station device with node devices in an industrial control ring network system when a node device fails according to an embodiment of the present disclosure.

FIG. 4 is a schematic flowchart illustrating a method for obtaining link node data according to an embodiment of the present disclosure.

FIG. 5 is a schematic flowchart illustrating a method for processing a message by a master station device according to an embodiment of the present disclosure.

FIG. 6 is a schematic flowchart illustrating a method for processing a link location acquisition message by a node device according to an embodiment of the present disclosure.

FIG. 7 is a schematic flowchart illustrating a method for processing a node data acquisition message by a node device according to an embodiment of the present disclosure.

FIG. 8 is a schematic structure diagram illustrating a system for obtaining link node data according to an embodiment of the present disclosure.

### DETAILED DESCRIPTION OF THE EMBODIMENTS

In order that the objectives, technical solutions and advantages of the present disclosure will become more apparent, the present disclosure will be described in more detail with reference to the drawings and examples above. It should be understood that the specific embodiments described herein are only for illustrating but not for limiting the scope of the present disclosure. Also, in the following description, descriptions of well-known structures and techniques are omitted to avoid unnecessarily obscuring the concepts of the present disclosure.

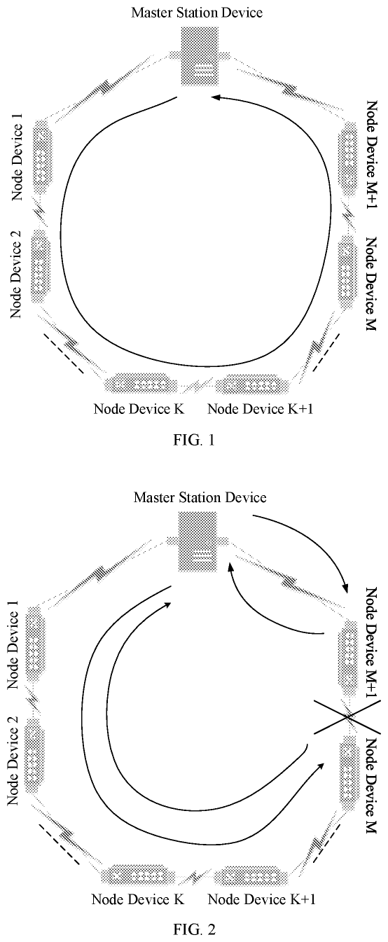

FIG. 1 is a schematic diagram illustrating a connection between a master station device with node devices in an industrial control ring network system when a link is in a normal state according to an embodiment of the present disclosure. As shown in FIG. 1, the industrial control ring network system can include a master station device and a plurality of node devices, the plurality of node devices can include, but not limited to, a node device 1, a node device 2, . . . , a node device K, a node device K+1, . . . , a node device M and a node device M+1 shown in FIG. 1, where K and M are positive integers and K<M. The master station device and the node devices or respective node devices are connected through Ethernet to form a closed ring network system structure. Specifically, the master station device and each of the plurality of node devices can include a master data transceiver port and a slave data transceiver port. The master data transceiver port of the master station device is connected with the master data transceiver port of the node device 1 through the Ethernet, and the slave data transceiver port of the node device 1 is connected with the master data transceiver port of the node device 2 through the Ethernet, by connecting in this order, the closed ring network system structure is formed. It should be noted that in the closed ring network system structure, the master data transceiver port of the master station device is mainly used for transmitting data, and the slave data transceiver port is mainly used for receiving the data; the master data transceiver port and the slave data transceiver port of the node device have no difference in function, and both can be used for receiving and transmitting the data.

FIG. 2 is a schematic diagram illustrating a connection between a master station device with node devices in an industrial control ring network system when a link is in an abnormal state according to an embodiment of the present disclosure. As shown in FIG. 2, when a link between the node device M and the node device M+1 in the industrial control ring network system is abnormal (that is, the link is disconnected), the master data transceiver port of the master station device is connected with the master data transceiver port of the node device 1 through the Ethernet, and the slave data transceiver port of the node device 1 is connected with the master data transceiver port of the node device 2 through the Ethernet, by connecting in this order, until the master data transceiver port of the node device M is connected; further, since the node device M is an endpoint device of the disconnected link, the master data transceiver port of the node device M is connected with the slave data transceiver port of a previous node device (for example, a node device M−1) through the Ethernet, by connecting in this order, until the master data transceiver port of the node device 1 is connected with the master data transceiver port of the master station device through the Ethernet, thereby forming a non-closed semi-ring network system structure, that is, a link branch corresponding to the master data transceiver port. In addition, the slave data transceiver port of the master station device is connected with the master data transceiver port of the node device M+1 through the Ethernet, similarly, since the node device M+1 is also an endpoint device of the disconnected link, the master data transceiver port of the node device M+1 is also connected with the slave data transceiver port of the master station device through the Ethernet, thereby forming another non-closed semi-ring network system structure, that is, a link branch corresponding to the slave data transceiver port. It should be noted that in the non-closed semi-ring network system structure, the master data transceiver port and the slave data transceiver port of the master station device have no difference in function, and both can be used for receiving and transmitting data.

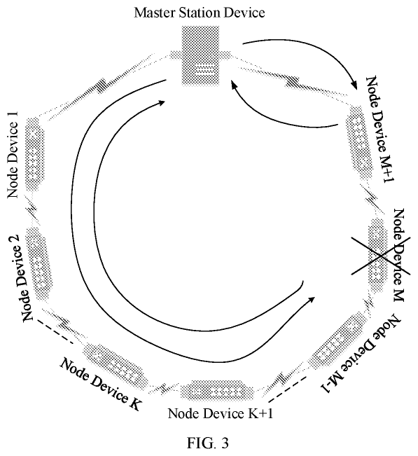

FIG. 3 is a schematic diagram illustrating a connection between a master station device with node devices in an industrial control ring network system when a node device fails according to an embodiment of the present disclosure. As shown in FIG. 3, when a node device (for example, the node device M) in the industrial control ring network system fails (that is, a ring network fails), the master data transceiver port of the master station device is connected with the master data transceiver port of the node device 1 through the Ethernet, and the slave data transceiver port of the node device 1 is connected with the master data transceiver port of the node device 2 through the Ethernet, by connecting in this order, until the master data transceiver port of the node device M−1 is connected; further, since the node device M−1 is an endpoint device adjacent to the failed node device M, the master data transceiver port of the node device M−1 is connected with the slave data transceiver port of a previous node device (for example, a node device M−2) through the Ethernet, by connecting in this order, until the master data transceiver port of the node device 1 is connected with the master data transceiver port of the master station device through the Ethernet, thereby forming a non-closed semi-ring network system structure, that is, a link branch corresponding to the master data transceiver port. In addition, the slave data transceiver port of the master station device is connected with the master data transceiver port of the node device M+1 through the Ethernet, similarly, since the node device M+1 is also an endpoint device of the disconnected link, the master data transceiver port of the node device M+1 is also connected with the slave data transceiver port of the master station device through the Ethernet, thereby forming another non-closed semi-ring network system structure, that is, a link branch corresponding to the slave data transceiver port.

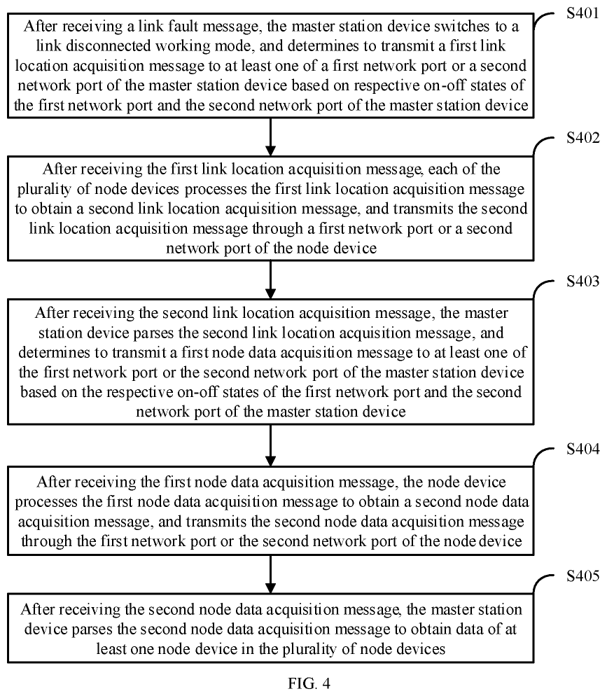

FIG. 4 is a schematic flowchart illustrating a method for obtaining link node data according to an embodiment of the present disclosure. The method for obtaining link node data in FIG. 4 can be applied to an industrial control ring network system including a master station device and a plurality of node devices. As shown in FIG. 4, the method can include the following steps:
S401, after receiving a link fault message, the master station device switches to a link disconnected working mode, and determines to transmit a first link location acquisition message to at least one of a first network port or a second network port of the master station device based on respective on-off states of the first network port and the second network port of the master station device;
S402, after receiving the first link location acquisition message, each of the plurality of node devices processes the first link location acquisition message to obtain a second link location acquisition message, and transmits the second link location acquisition message through a first network port or a second network port of the node device;
S403, after receiving the second link location acquisition message, the master station device parses the second link location acquisition message, and determines to transmit a first node data acquisition message to at least one of the first network port or the second network port of the master station device based on the respective on-off states of the first network port and the second network port of the master station device;
S404, after receiving the first node data acquisition message, the node device processes the first node data acquisition message to obtain a second node data acquisition message, and transmits the second node data acquisition message through the first network port or the second network port of the node device; and
S405, after receiving the second node data acquisition message, the master station device parses the second node data acquisition message to obtain data of at least one node device in the plurality of node devices.

According to the technical solutions provided by the embodiments of the present disclosure, when the link of the industrial control ring network system is interrupted, the master station device can quickly obtain the network topology after disconnection and perform network reorganization. Meanwhile, the master station device can make maximum use of the capacity of the network protocol to obtain the data of respective node devices according to the amount of data that respective node devices need to upload, and then can quickly obtain the data of respective node devices, thereby ensuring the real-time performance and reliability of the network of the industrial control ring network system.

In some embodiments, the master station device determines whether a link in a ring network is disconnected in real time according to link state information reported by a plurality of node devices on the link; when all links in a ring network are in a loop connected state, obtaining, by the master station device, the master station device obtains data of respective node devices in the plurality of node devices through a loop; and when a link between two node devices in the ring network fails or a node device fails, the node devices at both sides of a disconnected link respectively transmit the link fault message to the master station device.

In some embodiments, after both the first network port (for example, the main data transceiver port) and the second network port (for example, the slave data transceiver port) of the master station device receive the link fault message, the master station device switches a current working mode to the link disconnected working mode and interrupts an ongoing working process in the link disconnected working mode.

In some embodiments, determining to transmit the first link location acquisition message to at least one of the first network port or the second network port based on the respective on-off states of the first network port and the second network port of the master station device includes: the master station device determines whether one of the first network port and the second network port of the master station device is corresponding to a disconnected link; in response to that the first network port or the second network port of the master station device is corresponding to a disconnected link, the master station device only transmits the first link location acquisition message to the second network port or the first network port of the master station device (for example, if the first network port is corresponding to a disconnected link, the master station device only transmits the first link location acquisition message to the second network port); and in response to that none of the first network port and the second network port of the master station device is corresponding to a disconnected link, the master station device transmits the first link location acquisition message to a disconnected link through the first network port and the second network port of the master station device respectively.

Here, the first link location acquisition message is a broadcast message, and contents of the first link location acquisition message can include, but not limited to, a message command, a destination internet protocol (IP) address, an IP address of the master station device and a first link location serial number, where the destination IP address can be, for example, 255.255.255; the IP address of the master station device can be, for example, 192.168.1.255; and the first link location serial number can be initially set to 0.

In some embodiments, after receiving the first link location acquisition message, by each of the plurality of node devices, processing the first link location acquisition message to obtain the second link location acquisition message, and transmitting the second link location acquisition message through the first network port or the second network port of the node device includes: the node device determines whether a destination address of the first link location acquisition message is the IP address of the master station device; in response to that the destination address of the first link location acquisition message is the IP address of the master station device, the node device does not process the first link location acquisition message, and directly transmits the first link location acquisition message through the second network port of the node device; in response to that the destination address of the first link location acquisition message is the destination IP address of the broadcast message, the node device parses the first link location acquisition message to obtain the IP address of the master station device and the first link location serial number; the node device stores the IP address of the master station device, and adds 1 to the first link location serial number to obtain a second link location serial number; and the node device adds an IP address of the node device and the second link location serial number to an end of the first link location acquisition message to obtain a second link location acquisition message. Here, the IP address of the node device can be, for example, 192.168.1.1.

The node device determines whether the node device is an endpoint device of the disconnected link; in response to that the node device is the endpoint device of the disconnected link, the node device changes a destination address of the second link location acquisition message to the IP address of the master station device, and transmits the second link location acquisition message through the first network port of the node device; and in response to that the node device is not the endpoint device of the disconnected link, the node device transmits the second link location acquisition message through the second network port of the node device. It should be noted that the second link location acquisition message is a broadcast message, and the first network port and the second network port can be interchanged.

In some embodiments, after receiving the second link location acquisition message, by the master station device, parsing the second link location acquisition message includes: after the first network port or the second network port of the master station device receives the second link location acquisition message, the master station device parses the second link location acquisition message to obtain a number of node devices (represented by “m”, where m is a positive integer) on a link branch corresponding to the first network port or the second network port as well as an IP address and a link location serial number of each of the node devices, and creates a mapping relationship table between IP addresses and the link location serial numbers of the node device.

In some embodiments, determining to transmit the first node data acquisition message to at least one of the first network port or the second network port based on the respective on-off states of the first network port and the second network port of the master station device includes: in response to that the first network port or the second network port of the master station device is corresponding to a disconnected link, the master station device only transmits the first node data acquisition message through the second network port or the first network port of the master station device; and in response to that none of the first network port and the second network port of the master station device is disconnected (that is, both the first network port and the second network port of the master station device receive the second link location acquisition message), the master station device transmits a first node data acquisition message to a disconnected link through the first network port and the second network port of the master station device respectively.

Here, the first node data acquisition message is the broadcast message, and the message content of the first node data acquisition message can include, but not limited to, the message command, the destination IP address, a device serial number (represented by “s_site”, where s_site is greater than or equal to 1) of a starting node device in node devices that need to obtain data and a message length, where the destination IP address can be, for example, 255.255.255; the device serial number of the starting node device can be initially set to 1, and the message length can be, for example, 4 bytes.

In some embodiments, after receiving the first node data acquisition message, by the node device, processing the first node data acquisition message to obtain a second node data acquisition message, and transmitting the second node data acquisition message through the first network port or the second network port of the node device includes:
the node device determines whether a destination address of the first node data acquisition message is the IP address of the master station device; in response to that the destination address of the first node data acquisition message is the IP address of the master station device, the node device directly transmits the first node data acquisition message through the second port of the node device;
in response to that the destination address of the first node data acquisition message is the destination IP address of the broadcast message, the node device parses the first node data acquisition message to obtain the message length (represented by “Len0”, and the unit is bytes) of the first node data acquisition message and the device serial number of the starting node device;
the node device determines whether a sum of the message length of the first node data acquisition message and a data length (represented by “Len1”, and the unit is bytes) to be uploaded by the node device is less than or equal to a maximum data length (represented by “P”, and the unit is bytes) carried by a network protocol, for example, the maximum data length of a data area of a user datagram protocol (UDP) is 1472 bytes;
in response to that the sum of the message length of the first node data acquisition message and the data length to be uploaded by the node device is less than or equal to the maximum data length carried by the network protocol (that is, Len0+Len1<=p), the node device determines whether the device serial number of the starting node device is less than or equal to the link location serial number (represented by “x”, and x is a positive integer) of the node device (that is, s_site<=x); in response to that the device serial number of the starting node device is less than or equal to the link location serial number of the node device, the node device adds an IP address of the node device and data to be uploaded to an end of the first node data acquisition message to obtain a second node data acquisition message; the node device determines whether the node device is an endpoint device of the disconnected link; in response to that the node device is the endpoint device of the disconnected link, the node device changes a destination address of the second node data acquisition message to the IP address of the IP address of the master station device, and transmits the second node data acquisition message through the first network port of the node device; and in response to that the node device is not the endpoint device of the disconnected link, the node device transmits the second node data acquisition message through the second network port of the node device; in response to that the device serial number of the starting node device is greater than the link location serial number of the node device (that is, s_site>x), the node device directly transmits the first node data acquisition message through the second network port of the node device;
in response to that the sum of the message length of the first node data acquisition message and the data length to be uploaded by the node device is greater than the maximum data length carried by the network protocol (that is, Len0+Len1>p), the node device determines whether the node device is the endpoint device of the disconnected link; in response to that the node device is the endpoint device of the disconnected link, the node device changes the destination address of the first node data acquisition message to the IP address of the IP address of the master station device, and transmits the first node data acquisition message through the first network port of the node device; and in response to that the node device is not the endpoint device of the disconnected link, the node device transmits the first node data acquisition message through the second network port of the node device, and keeps the destination address unchanged.

In some embodiments, after receiving the second node data acquisition message, by the master station device, parsing the second node data acquisition message to obtain data of at least one node device in the plurality of node devices includes: after the first network port or the second network port of the master station device receives the second node data acquisition message, the master station device parses the second node data acquisition message to obtain data of respective node devices and an IP address of a last node device in the second node data acquisition message, and obtains a link location serial number (represented by “y”, where y is a positive integer and y<=m) corresponding to the IP address of the last node device according to the mapping relationship table; the master station device determines whether the link location serial number of the last node device is less than the number of node devices on the link branch; in response to that the link location serial number of the last node device is less than the number of node devices on the link branch (that is, y<m), the master station device adds 1 to a device serial number of a starting node device in node devices (that is, the device serial number of the starting node device is set to y+1), and transmits the first node data acquisition message through the first network port or the second network port of the master station device, where the first node data acquisition message is a broadcast message; and in response to that the link location serial number of the last node device is equal to the number of node devices on the link branch (that is, y=m), the master station device transmits the first node data acquisition message through the first network port or the second network port of the master station device, where the device serial number of the starting node device in node devices that need to obtain data in the first node data acquisition message is set to 1, and the first node data acquisition message is a broadcast message.

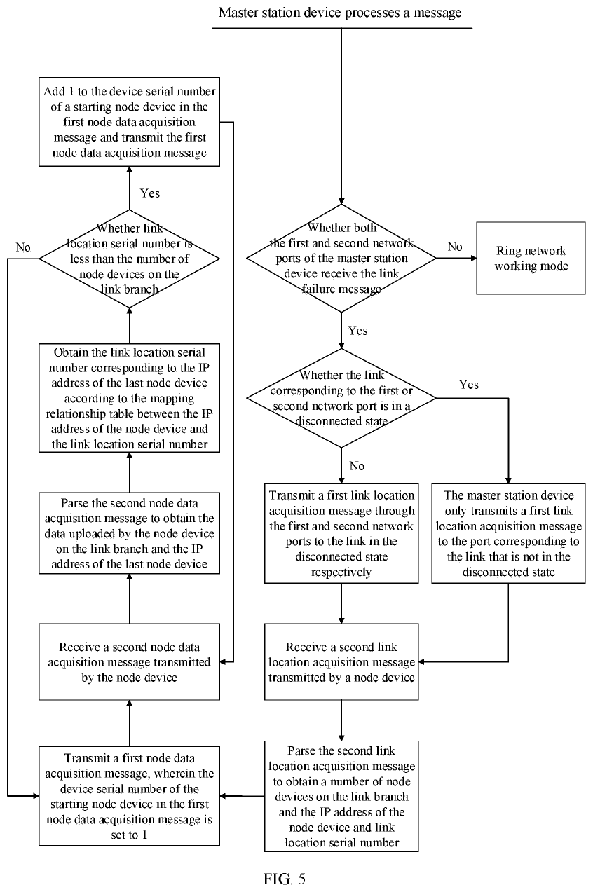

FIG. 5 is a schematic flowchart illustrating a method for processing a message by a master station device according to an embodiment of the present disclosure. As shown in FIG. 5, a process controlled by the master station device includes following contents.

The master station device determines whether a link in a ring network is disconnected in real time according to link state information reported by a plurality of node devices on the link; when all links in a ring network are in a loop connected state, obtaining, by the master station device, the master station device obtains data of respective node devices in the plurality of node devices through a loop; and when a link between two node devices in the ring network fails or a node device fails, the node devices at both sides of a disconnected link respectively transmit the link fault message to the master station device. After both the first network port and the second network port of the master station device receive the link fault message, the master station device switches a current working mode to the link disconnected working mode and interrupts an ongoing working process in the link disconnected working mode. The master station device determines whether one of the first network port and the second network port of the master station device is corresponding to a disconnected link; in response to that the first network port or the second network port of the master station device is corresponding to a disconnected link, the master station device only transmits the first link location acquisition message to the second network port or the first network port (that is, a port corresponding to the link not disconnected) of the master station device (for example, if the first network port is corresponding to a disconnected link, the master station device only transmits the first link location acquisition message to the second network port); and in response to that none of the first network port and the second network port of the master station device is corresponding to a disconnected link, the master station device transmits the first link location acquisition message to a disconnected link through the first network port and the second network port of the master station device respectively. Here, the first link location acquisition message is a broadcast message, and contents of the first link location acquisition message can include, but not limited to, a message command, a destination internet protocol (IP) address, an IP address of the master station device and a first link location serial number, where the destination IP address can be, for example, 255.255.255; the IP address of the master station device can be, for example, 192.168.1.255; and the first link location serial number can be initially set to 0. After the first network port or the second network port of the master station device receives the second link location acquisition message, the master station device parses the second link location acquisition message to obtain a number of node devices (represented by “m”, where m is a positive integer) on a link branch corresponding to the first network port or the second network port as well as an IP address and a link location serial number of each of the node devices, and creates a mapping relationship table between IP addresses and link location serial numbers of the node device.

In response to that the first network port or the second network port of the master station device is corresponding to a disconnected link, the master station device only transmits the first node data acquisition message through the second network port or the first network port of the master station device; and in response to that none of the first network port and the second network port of the master station device is disconnected (that is, both the first network port and the second network port of the master station device receive the second link location acquisition message), the master station device transmits a first node data acquisition message to a disconnected link through the first network port and the second network port of the master station device respectively. Here, the first node data acquisition message is the broadcast message, and the message content of the first node data acquisition message can include, but not limited to, the message command, the destination IP address, a device serial number (represented by “s_site”, where s_site is greater than or equal to 1) of a starting node device in node devices that need to obtain data and a message length, where the destination IP address can be, for example, 255.255.255; the device serial number of the starting node device can be initially set to 1, and the message length can be, for example, 4 bytes.

After the first network port or the second network port of the master station device receives the second node data acquisition message, the master station device parses the second node data acquisition message to obtain data of respective node devices and an IP address of a last node device in the second node data acquisition message, and obtains a link location serial number (represented by “y”, where y is a positive integer and y<=m) corresponding to the IP address of the last node device according to the mapping relationship table.

The master station device determines whether the link location serial number of the last node device is less than the number of node devices on the link branch; in response to that the link location serial number of the last node device is less than the number of node devices on the link branch (that is, y<m), the master station device adds 1 to a device serial number of a starting node device in node devices (that is, the device serial number of the starting node device is set to y+1), and transmits the first node data acquisition message through the first network port or the second network port of the master station device, where the first node data acquisition message is a broadcast message; and in response to that the link location serial number of the last node device is equal to the number of node devices on the link branch (that is, y=m), the master station device transmits the first node data acquisition message through the first network port or the second network port of the master station device, where the device serial number of the starting node device in node devices that need to obtain data in the first node data acquisition message is set to 1, and the first node data acquisition message is a broadcast message.

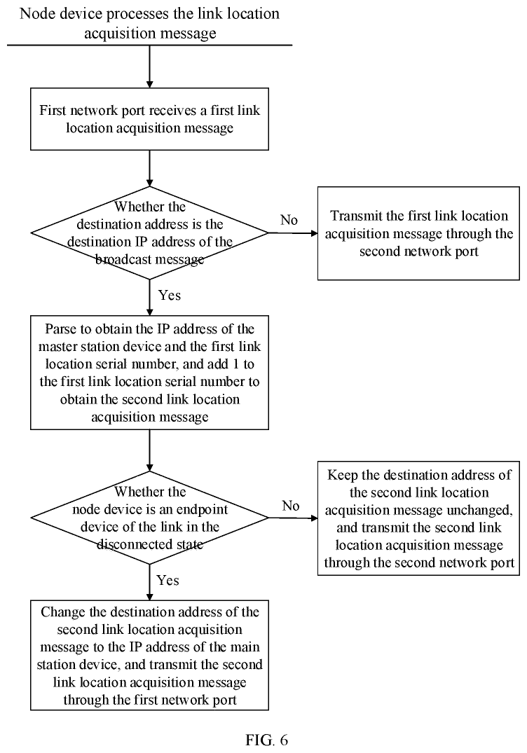

FIG. 6 is a schematic flowchart illustrating a method for processing a link location acquisition message by a node device according to an embodiment of the present disclosure. As shown in FIG. 6, a process of processing the link location acquisition message by the node device includes the following contents.

The node device determines whether a destination address of the first link location acquisition message is the IP address of the master station device; in response to that the destination address of the first link location acquisition message is the IP address of the master station device, the node device does not process the first link location acquisition message, and directly transmits the first link location acquisition message through the second network port of the node device; in response to that the destination address of the first link location acquisition message is the destination IP address of the broadcast message, the node device parses the first link location acquisition message to obtain the IP address of the master station device and the first link location serial number; the node device stores the IP address of the master station device, and adds 1 to the first link location serial number to obtain a second link location serial number; and the node device adds an IP address of the node device and the second link location serial number to an end of the first link location acquisition message to obtain a second link location acquisition message. Here, the IP address of the node device can be, for example, 192.168.1.1. The node device determines whether the node device is an endpoint device of the disconnected link; in response to that the node device is the endpoint device of the disconnected link, the node device changes a destination address of the second link location acquisition message to the IP address of the master station device, and transmits the second link location acquisition message through the first network port of the node device; and in response to that the node device is not the endpoint device of the disconnected link, the node device transmits the second link location acquisition message through the second network port of the node device. It should be noted that the second link location acquisition message is a broadcast message, and the first network port and the second network port can be interchanged.

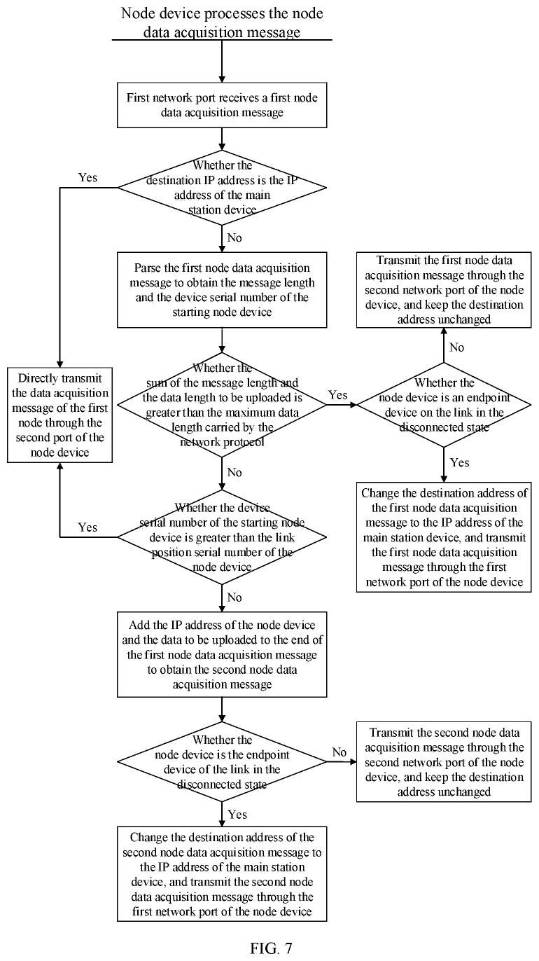

FIG. 7 is a schematic flowchart illustrating a method for processing a node data acquisition message by a node device according to an embodiment of the present disclosure. As shown in FIG. 7, a process of processing the node data acquisition message by the node device includes the following contents.

The node device determines whether a destination address of the first node data acquisition message is the IP address of the master station device; in response to that the destination address of the first node data acquisition message is the IP address of the master station device, the node device directly transmits the first node data acquisition message through the second port of the node device. In response to that the destination address of the first node data acquisition message is the destination IP address of the broadcast message, the node device parses the first node data acquisition message to obtain the message length (represented by “Len0”, and the unit is bytes) of the first node data acquisition message and the device serial number of the starting node device. The node device determines whether a sum of the message length of the first node data acquisition message and a data length (represented by “Len1”, and the unit is bytes) to be uploaded by the node device is less than or equal to a maximum data length (represented by “P”, and the unit is bytes) carried by a network protocol, for example, the maximum data length of a data area of a user datagram protocol (UDP) is 1472 bytes. In response to that the sum of the message length of the first node data acquisition message and the data length to be uploaded by the node device is less than or equal to the maximum data length carried by the network protocol (that is, Len0+Len1<=p), the node device determines whether the device serial number of the starting node device is less than or equal to the link location serial number (represented by “x”, and x is a positive integer) of the node device (that is, s_site<=x); in response to that the device serial number of the starting node device is less than or equal to the link location serial number of the node device, the node device adds an IP address of the node device and data to be uploaded to an end of the first node data acquisition message to obtain a second node data acquisition message; the node device determines whether the node device is an endpoint device of the disconnected link; in response to that the node device is the endpoint device of the disconnected link, the node device changes a destination address of the second node data acquisition message to the IP address of the IP address of the master station device, and transmits the second node data acquisition message through the first network port of the node device; and in response to that the node device is not the endpoint device of the disconnected link, the node device transmits the second node data acquisition message through the second network port of the node device; in response to that the device serial number of the starting node device is greater than the link location serial number of the node device (that is, s_site>x), the node device directly transmits the first node data acquisition message through the second network port of the node device. In response to that the sum of the message length of the first node data acquisition message and the data length to be uploaded by the node device is greater than the maximum data length carried by the network protocol (that is, Len0+Len1>p), the node device determines whether the node device is the endpoint device of the disconnected link; in response to that the node device is the endpoint device of the disconnected link, the node device changes the destination address of the first node data acquisition message to the IP address of the IP address of the master station device, and transmits the first node data acquisition message through the first network port of the node device; and in response to that the node device is not the endpoint device of the disconnected link, the node device transmits the first node data acquisition message through the second network port of the node device, and keeps the destination address unchanged.

### First Embodiment

Referring to FIG. 1 to FIG. 4, the embodiment of the present disclosure provides a method for obtaining link node data. The industrial control ring network system includes one master station device and ten node devices, which are connected with each other through Ethernet to form a closed ring network system structure. The method for obtaining link node data can include the following steps.
1) The master station device obtains data of respective node devices, where the data can include normal data and a link fault message.
2) After both the first network port and the second network port of the master station device receive the link fault message, the master station device switches a current working mode to the link disconnected working mode and interrupts an ongoing working process in the link disconnected working mode; further, the master station device determines to transmit the first link location acquisition message to at least one of the first network port or the second network port based on the respective on-off states of the first network port and the second network port of the master station device.
3) After receiving the first link location acquisition message, each of the node devices processes the first link location acquisition message to obtain a second link location acquisition message, and transmits the second link location acquisition message through a first network port or a second network port of the node device.
4) After the first network port or the second network port of the master station device receives the second link location acquisition message, the master station device parses the second link location acquisition message to obtain a number of node devices on a link branch corresponding to the first network port or the second network port as well as an IP address and a link location serial number of each of the node devices, and creates a mapping relationship table between IP addresses and link location serial numbers of the node device.
5) After receiving the second link location acquisition message, the master station device parses the second link location acquisition message, and determines to transmit a first node data acquisition message to at least one of the first network port or the second network port based on the respective on-off states of the first network port and the second network port of the master station device.
6) After receiving the first node data acquisition message, the node device processes the first node data acquisition message to obtain a second node data acquisition message, and transmits the second node data acquisition message through the first network port or the second network port of the node device.
7) After receiving the second node data acquisition message, the master station device parses the second node data acquisition message to obtain data of at least one node device in the plurality of node devices.

Hereinafter, the specific determination method of step 1) is illustrated by an example. When all links in a ring network are in a loop connected state, the master station device obtains data of respective node devices through a loop. Assuming that a link between the node device 3 and the node device 4 in FIG. 1 is abnormal, node devices at both sides of the disconnected link respectively transmit link fault messages to the master station device.

The master station device determines whether one of the first network port and the second network port of the master station device is corresponding to a disconnected link according to the received link fault messages; in response to that the first network port or the second network port of the master station device is corresponding to a disconnected link, the master station device only transmits the first link location acquisition message to the second network port or the first network port of the master station device; and in response to that none of the first network port and the second network port of the master station device is corresponding to a disconnected link, the master station device transmits the first link location acquisition message to a disconnected link through the first network port and the second network port of the master station device respectively, where the first link location acquisition message is a broadcast message including a destination IP address, and the first link location acquisition message further includes a message command, an IP address of the master station device and a first link location serial number of the master station device.

After receiving the first link location acquisition message, processing, by the node device, the first link location acquisition message includes the following steps.
1) The node device determines whether a destination address of the first link location acquisition message is the IP address of the master station device; in response to that the destination address of the first link location acquisition message is the IP address of the master station device, the node device does not process the first link location acquisition message, and directly transmits the first link location acquisition message through the second network port of the node device.
2) In response to that the destination address of the first link location acquisition message is the destination IP address of the broadcast message, the node device parses the first link location acquisition message to obtain the IP address of the master station device and the first link location serial number; the node device stores the IP address of the master station device, and adds 1 to the first link location serial number to obtain a second link location serial number.
3) The node device adds an IP address of the node device and the second link location serial number to an end of the first link location acquisition message to obtain a second link location acquisition message.
4) The node device determines whether the node device is an endpoint device of the disconnected link; in response to that the node device is the endpoint device of the disconnected link, the node device changes a destination address of the second link location acquisition message to the IP address of the master station device, and transmits the second link location acquisition message through the first network port of the node device; and in response to that the node device is not the endpoint device of the disconnected link, the node device transmits the second link location acquisition message through the second network port of the node device, where the second link location acquisition message is a broadcast message.

After receiving the second link location acquisition message, an endpoint device (for example, the node device 3 or the node device 4) on the disconnected link changes a destination address of the second link location acquisition message to the IP address of the master station device, and transmits the second link location acquisition message through the first network port of the node device.

In response to that the first network port or the second network port of the master station device is corresponding to a disconnected link, the master station device only transmits the first node data acquisition message through the second network port or the first network port of the master station device; and in response to that none of the first network port and the second network port of the master station device is disconnected (that is, both the first network port and the second network port of the master station device receive the second link location acquisition message), the master station device transmits a first node data acquisition message to a disconnected link through the first network port and the second network port of the master station device respectively. The first node data acquisition message is the broadcast message, and the message content of the first node data acquisition message can include, but not limited to, the message command, the destination IP address, a device serial number of a starting node device in node devices that need to obtain data.

After receiving the first node data acquisition message, by the node device, processing the first node data acquisition message to obtain a second node data acquisition message, and transmitting the second node data acquisition message through the first network port or the second network port of the node device includes the following contents.
1) The node device determines whether a destination address of the first node data acquisition message is the IP address of the master station device; in response to that the destination address of the first node data acquisition message is the IP address of the master station device, the node device directly transmits the first node data acquisition message through the second port of the node device.
2) In response to that the destination address of the first node data acquisition message is the destination IP address of the broadcast message, the node device parses the first node data acquisition message to obtain the message length (represented by “Len0”, and the unit is bytes) of the first node data acquisition message and the device serial number of the starting node device.
3) The node device determines whether a sum of the message length of the first node data acquisition message and a data length (represented by “Len1”, and the unit is bytes) to be uploaded by the node device is less than or equal to a maximum data length (represented by “P”, and the unit is bytes) carried by a network protocol, for example, the maximum data length of a data area of a user datagram protocol (UDP) is 1472 bytes.
4) In response to that the sum of the message length of the first node data acquisition message and the data length to be uploaded by the node device is less than or equal to the maximum data length carried by the network protocol (that is, Len0+Len1<=p), the node device determines whether the device serial number of the starting node device is less than or equal to the link location serial number (represented by “x”, and x is a positive integer) of the node device (that is, s_site<=x); in response to that the device serial number of the starting node device is less than or equal to the link location serial number of the node device, the node device adds an IP address of the node device and data to be uploaded to an end of the first node data acquisition message to obtain a second node data acquisition message; the node device determines whether the node device is an endpoint device of the disconnected link; in response to that the node device is the endpoint device of the disconnected link, the node device changes a destination address of the second node data acquisition message to the IP address of the IP address of the master station device, and transmits the second node data acquisition message through the first network port of the node device; and in response to that the node device is not the endpoint device of the disconnected link, the node device transmits the second node data acquisition message through the second network port of the node device; in response to that the device serial number of the starting node device is greater than the link location serial number of the node device (that is, s_site>x), the node device directly transmits the first node data acquisition message through the second network port of the node device.
5) In response to that the sum of the message length of the first node data acquisition message and the data length to be uploaded by the node device is greater than the maximum data length carried by the network protocol (that is, Len0+Len1>p), the node device determines whether the node device is the endpoint device of the disconnected link; in response to that the node device is the endpoint device of the disconnected link, the node device changes the destination address of the first node data acquisition message to the IP address of the IP address of the master station device, and transmits the first node data acquisition message through the first network port of the node device; and in response to that the node device is not the endpoint device of the disconnected link, the node device transmits the first node data acquisition message through the second network port of the node device, and keeps the destination address unchanged.

Processing, by the master station device, the received second node data acquisition message includes the following substeps.
1) After the first network port or the second network port of the master station device receives the second node data acquisition message, the master station device parses the second node data acquisition message to obtain data of respective node devices and an IP address of a last node device in the second node data acquisition message, and obtains a link location serial number corresponding to the IP address of the last node device according to the mapping relationship table.
2) The master station device determines whether the link location serial number of the last node device is less than the number of node devices on the link branch.
3) In response to that the link location serial number of the last node device is less than the number of node devices on the link branch, for example, the link location serial number corresponding to the IP address of the last node device in the second node data acquisition message is 2 and the number of node devices is 3, the master station device transmits the first node data acquisition message to a network port corresponding to the link branch, where the device serial number of the starting node device in node devices that need to obtain data in the first node data acquisition message is set to add 1 to the link location serial number, that is, the device serial number is set to 3; and the first node data acquisition message is a broadcast message.
4) In response to that the link location serial number of the last node device is equal to the number of node devices on the link branch, for example, the link location serial number corresponding to the IP address of the last node device in the second node data acquisition message is 3 and the number of node devices is also 3, the master station device transmits the first node data acquisition message to a network port corresponding to the link branch, where the device serial number of the starting node device in node devices that need to obtain data in the first node data acquisition message is set to 1, and the first node data acquisition message is a broadcast message.

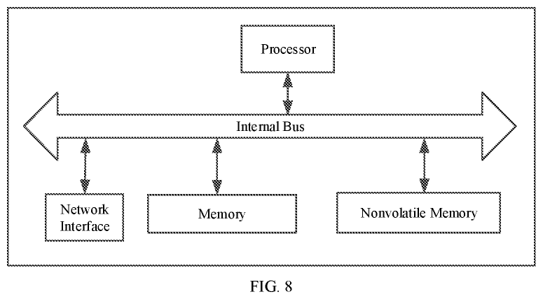

The embodiments of a system for obtaining link node data of the present disclosure can be applied to any device with data processing capability, which can be a device or an apparatus such as a computer. The embodiments of the apparatus can be implemented by software, or by hardware or a combination of software and hardware. Taking software implementation as an example, as an apparatus in a logical sense, it is formed by reading the corresponding computer program instructions in the non-volatile memory into the memory through the processor of any device with data processing capability where it is located. In terms of hardware, as shown in FIG. 8, FIG. 8 is a hardware structure diagram illustrating any device with data processing capability where a system for obtaining link node data according to the embodiments of the present disclosure is located. In addition to a processor, a memory, a network interface and a nonvolatile memory shown in FIG. 8, any device with data processing capability in which the apparatus is located in the embodiments may generally include other hardware according to the actual functions of any device with data processing capability, details of which will not be described herein. The implementation of the functions and effects of each module in the above apparatus may refer to the implementation of the corresponding steps in the foregoing method, and detail is not described herein again.

For the apparatus embodiment, since it basically corresponds to the method embodiment, the relevant part may refer to the part of the description of the method embodiment. The apparatus embodiments described above are merely illustrative, where the units described as separate components may or may not be physically separated, and the components displayed as units may or may not be physical units. That is, they may be located in one place or may be distributed to a plurality of network units. Some or all of the modules may be selected according to actual needs, to achieve the objectives of the solutions of the present disclosure. Those skilled in the art may understand and implement without creative labor.

The embodiments of the present disclosure provides a computer readable storage medium storing programs thereon, wherein when the programs are executed by one or more processors, the method and system for obtaining link node data described in any one of the above embodiments is implemented.

The computer readable storage medium can be an internal storage unit of any device with data processing capability described in any one of the foregoing embodiments, for example, a hard disk or a memory. Alternatively, the computer readable storage medium can be an external storage device of any device with data processing capability, for example, a plug-in hard disk, a smart media card (SMC), a secure digital (SD) card, a flash card, or the like that is configured on the device. Further, the computer readable storage medium can include both an internal storage unit and an external storage device of any device with data processing capability. The computer readable storage medium is configured to store the computer program and other programs and data that are required by any device with data processing capability. The computer readable storage medium can be further configured to temporarily store data that has been output or is to be output.

The above are only preferred examples of the present disclosure, and are not intended to limit the present disclosure. Any modification, equivalent replacement, or improvement made within the spirit and principles of the present disclosure shall be included in the protection scope of the present disclosure.

1. A method for obtaining link node data, being applicable to an industrial control ring network system, wherein the industrial control ring network system comprises a master station device and a plurality of node devices, the method comprising:
after receiving a link fault message, by the master station device, switching to a link disconnected working mode, and determining to transmit a first link location acquisition message to at least one of a first network port or a second network port of the master station device based on respective on-off states of the first network port and the second network port of the master station device;
after receiving the first link location acquisition message, by each of the plurality of node devices, processing the first link location acquisition message to obtain a second link location acquisition message, and transmitting the second link location acquisition message through a first network port or a second network port of the node device;
after receiving the second link location acquisition message, by the master station device, parsing the second link location acquisition message, and determining to transmit a first node data acquisition message to at least one of the first network port or the second network port of the master station device based on the respective on-off states of the first network port and the second network port of the master station device;
after receiving the first node data acquisition message, by the node device, processing the first node data acquisition message to obtain a second node data acquisition message, and transmitting the second node data acquisition message through the first network port or the second network port of the node device; and
after receiving the second node data acquisition message, by the master station device, parsing the second node data acquisition message to obtain data of at least one node device in the plurality of node devices.

2. The method according to claim 1, wherein before receiving the link fault message, the method further comprises:
when all links in a ring network are in a loop connected state, obtaining, by the master station device, data of respective node devices through a loop; and
when a link between two node devices in the ring network fails or a node device fails, respectively transmitting, by node devices at both sides of a disconnected link, the link fault message to the master station device.

3. The method according to claim 1, wherein determining to transmit the first link location acquisition message to at least one of the first network port or the second network port of the master station device based on the respective on-off states of the first network port and the second network port of the master station device comprises:
determining, by the master station device, whether one of the first network port and the second network port of the master station device is corresponding to a disconnected link;
in response to that the first network port of the master station device is corresponding to a disconnected link, transmitting, by the master station device, the first link location acquisition message to the second network port of the master station device;
in response to that the second network port of the master station device is corresponding to a disconnected link, transmitting, by the master station device, the first link location acquisition message to the first network port of the master station device; and
in response to that none of the first network port and the second network port of the master station device is corresponding to a disconnected link, transmitting, by the master station device, the first link location acquisition message to a disconnected link through the first network port and the second network port of the master station device respectively,
wherein the first link location acquisition message is a broadcast message and comprises a message command, a destination internet protocol (IP) address, an IP address of the master station device and a first link location serial number.

4. The method according to claim 3, wherein after receiving the first link location acquisition message, by each of the plurality of node devices, processing the first link location acquisition message to obtain the second link location acquisition message, and transmitting the second link location acquisition message through the first network port or the second network port of the node device comprises:
determining, by the node device, whether a destination address of the first link location acquisition message is the IP address of the master station device;
in response to that the destination address of the first link location acquisition message is the IP address of the master station device, by the node device, not processing the first link location acquisition message, and directly transmitting the first link location acquisition message through the second network port of the node device;
in response to that the destination address of the first link location acquisition message is the destination IP address of the broadcast message, parsing, by the node device, the first link location acquisition message to obtain the IP address of the master station device and the first link location serial number;
by the node device, storing the IP address of the master station device, and adding 1 to the first link location serial number to obtain a second link location serial number;
adding, by the node device, an IP address of the node device and the second link location serial number to an end of the first link location acquisition message to obtain a second link location acquisition message;
determining, by the node device, whether the node device is an endpoint device of the disconnected link;
in response to that the node device is the endpoint device of the disconnected link, by the node device, changing a destination address of the second link location acquisition message to the IP address of the master station device, and transmitting the second link location acquisition message through the first network port of the node device; and
in response to that the node device is not the endpoint device of the disconnected link, transmitting, by the node device, the second link location acquisition message through the second network port of the node device.

5. The method according to claim 1, wherein after receiving the second link location acquisition message, by the master station device, parsing the second link location acquisition message comprises:
after the first network port or the second network port of the master station device receives the second link location acquisition message, by the master station device, parsing the second link location acquisition message to obtain a number of node devices on a link branch corresponding to the first network port or the second network port together with an IP address and a link location serial number of each of the node devices, and creating a mapping relationship table between IP addresses and link location serial numbers of the node devices.

6. The method according to claim 3, wherein determining to transmit the first node data acquisition message to at least one of the first network port or the second network port of the master station device based on the respective on-off states of the first network port and the second network port of the master station device comprises:
in response to that the first network port of the master station device is corresponding to a disconnected link, transmitting, by the master station device, the first node data acquisition message to the disconnected link through the second network port of the master station device;
in response to that the second network port of the master station device is corresponding to a disconnected link, transmitting, by the master station device, the first node data acquisition message to the disconnected link through the first network port of the master station device; and
in response to that both the first network port and the second network port of the master station device receive the second link location acquisition message, transmitting, by the master station device, a first node data acquisition message to a disconnected link through the first network port and the second network port of the master station device respectively,
wherein the first node data acquisition message is the broadcast message and comprises the message command, the destination IP address, a device serial number of a starting node device in node devices that need to obtain data and a message length.

7. The method according to claim 3, wherein after receiving the first node data acquisition message, by the node device, processing the first node data acquisition message to obtain a second node data acquisition message, and transmitting the second node data acquisition message through the first network port or the second network port of the node device comprises:
determining, by the node device, whether a destination address of the first node data acquisition message is the IP address of the master station device;
in response to that the destination address of the first node data acquisition message is the IP address of the master station device, directly transmitting, by the node device, the first node data acquisition message through the second port of the node device;
in response to that the destination address of the first node data acquisition message is the destination IP address of the broadcast message, parsing, by the node device, the first node data acquisition message to obtain the message length of the first node data acquisition message and the device serial number of the starting node device;
determining, by the node device, whether a sum of the message length of the first node data acquisition message and a data length to be uploaded by the node device is less than or equal to a maximum data length carried by a network protocol;
in response to that the sum of the message length of the first node data acquisition message and the data length to be uploaded by the node device is less than or equal to the maximum data length carried by the network protocol,
determining, by the node device, whether the device serial number of the starting node device is less than or equal to the link location serial number of the node device;
in response to that the device serial number of the starting node device is less than or equal to the link location serial number of the node device,
adding, by the node device, an IP address of the node device and data to be uploaded to an end of the first node data acquisition message to obtain a second node data acquisition message;
determining, by the node device, whether the node device is an endpoint device of the disconnected link;
in response to that the node device is the endpoint device of the disconnected link, by the node device, changing a destination address of the second node data acquisition message to the IP address of the IP address of the master station device, and transmitting the second node data acquisition message through the first network port of the node device; and
in response to that the node device is not the endpoint device of the disconnected link, transmitting, by the node device, the second node data acquisition message through the second network port of the node device;
in response to that the device serial number of the starting node device is greater than the link location serial number of the node device, directly transmitting, by the node device, the first node data acquisition message through the second network port of the node device;
in response to that the sum of the message length of the first node data acquisition message and the data length to be uploaded by the node device is greater than the maximum data length carried by the network protocol,
determining, by the node device, whether the node device is the endpoint device of the disconnected link;
in response to that the node device is the endpoint device of the disconnected link, by the node device, changing the destination address of the first node data acquisition message to the IP address of the IP address of the master station device, and transmitting the first node data acquisition message through the first network port of the node device; and
in response to that the node device is not the endpoint device of the disconnected link, transmitting, by the node device, the first node data acquisition message through the second network port of the node device.

8. The method according to claim 5, wherein after receiving the second node data acquisition message, by the master station device, parsing the second node data acquisition message to obtain data of at least one node device in the plurality of node devices comprises:
after the first network port or the second network port of the master station device receives the second node data acquisition message, by the master station device, parsing the second node data acquisition message to obtain data of respective node devices and an IP address of a last node device in the second node data acquisition message, and obtaining a link location serial number corresponding to the IP address of the last node device according to the mapping relationship table;
determining, by the master station device, whether the link location serial number of the last node device is less than the number of node devices on the link branch;
in response to that the link location serial number of the last node device is less than the number of node devices on the link branch, by the master station device, adding 1 to a device serial number of a starting node device in node devices that need to obtain data in the first node data acquisition message, and transmitting the first node data acquisition message through the first network port or the second network port of the master station device; and
in response to that the link location serial number of the last node device is equal to the number of node devices on the link branch, transmitting, by the master station device, the first node data acquisition message through the first network port or the second network port of the master station device, wherein the device serial number of the starting node device in node devices that need to obtain data in the first node data acquisition message is unchanged.

9. A system for obtaining link node data, comprising a memory and one or more processors, wherein the memory stores executable codes, and when executed by the processors, the executable codes cause the processors to:
after receiving a link fault message, by the master station device, switch to a link disconnected working mode, and determine to transmit a first link location acquisition message to at least one of a first network port or a second network port based on respective on-off states of the first network port and the second network port of the master station device;
after receiving the first link location acquisition message, by each of the plurality of node devices, process the first link location acquisition message to obtain a second link location acquisition message, and transmit the second link location acquisition message through a first network port or a second network port of the node device;
after receiving the second link location acquisition message, by the master station device, parse the second link location acquisition message, and determine to transmit a first node data acquisition message to at least one of the first network port or the second network port based on the respective on-off states of the first network port and the second network port of the master station device;
after receiving the first node data acquisition message, by the node device, process the first node data acquisition message to obtain a second node data acquisition message, and transmit the second node data acquisition message through the first network port or the second network port of the node device; and
after receiving the second node data acquisition message, by the master station device, parse the second node data acquisition message to obtain data of at least one node device in the plurality of node devices.

10. A computer readable storage medium, storing programs thereon, wherein when executed by one or more processors, the programs cause the processors to:
after receiving a link fault message, by the master station device, switch to a link disconnected working mode, and determine to transmit a first link location acquisition message to at least one of a first network port or a second network port of the master station device based on respective on-off states of the first network port and the second network port of the master station device;
after receiving the first link location acquisition message, by each of the plurality of node devices, process the first link location acquisition message to obtain a second link location acquisition message, and transmit the second link location acquisition message through a first network port or a second network port of the node device;
after receiving the second link location acquisition message, by the master station device, parse the second link location acquisition message, and determine to transmit a first node data acquisition message to at least one of the first network port or the second network port of the master station device based on the respective on-off states of the first network port and the second network port of the master station device;
after receiving the first node data acquisition message, by the node device, process the first node data acquisition message to obtain a second node data acquisition message, and transmit the second node data acquisition message through the first network port or the second network port of the node device; and
after receiving the second node data acquisition message, by the master station device, parse the second node data acquisition message to obtain data of at least one node device in the plurality of node devices.
